(19) United States
(12) Patent Application Publication
(10) Pub. No.: US 2021/0188520 A1
(43) Pub. Date: Jun. 24, 2021

(54) Storage box having fireproof and heat-insulating functions

(71) Applicant: Shenzhen Yihuaxing Technology Co., Ltd., Shenzhen (CN)

(72) Inventor: Yuming Liu, Lianyuan (CN)

(73) Assignee: Shenzhen Yihuaxing Technology Co., Ltd.

(21) Appl. No.: 17/194,315

(22) Filed: Mar. 8, 2021

(30) Foreign Application Priority Data
Dec. 5, 2020 (CN) 202011417605.2

(51) Int. Cl. B65D 81/38; B65D 55/14; B65D 51/18; B65D 25/28; B65D 25/20

(52) U.S. Cl. CPC B65D 81/3813; B65D 55/145; B65D 51/18; B65D 2251/0081; B65D 25/20; B65D 2251/0018; B65D 25/2885

(57) ABSTRACT

The present disclosure discloses a storage box having fireproof and heat-insulating functions, and relates to the field of storage boxes. The storage box having fireproof and heat-insulating functions includes a folding storage box body provided with a code lock, where the folding storage box body is provided with a box cover, the box cover matches the folding storage box body, a top cover is arranged above the folding storage box body, a same zipper is sewn on the folding storage box body and the top cover, and two zipper heads are movably installed on the zipper.

### TECHNICAL FIELD

The present disclosure relates to the technical field of storage boxes, and in particular, to a storage box having fireproof and heat-insulating functions.

### BACKGROUND

Important documents, files, certificates, and precious items are stored in all walks of life and families, but countless important items, documents and files are damaged every year because of fires, and an entire vehicle of important documents were ever burned in logistics and transportation.

At present, there are no fireproof products and solutions for the storage of important documents and files and valuables on the market. They are all stored in storage boxes that do not have a fireproof function. However, fire accidents occur frequently. Once a fire source is in contact with a storage box that does not have the fireproof function, documents, files, and valuables are all destroyed. Therefore, a storage box having fireproof and heat-insulating functions is needed to meet user's needs.

### SUMMARY

An objective of the present disclosure is to provide a storage box having fireproof and heat-insulating functions, to solve the problems that fireproof products and solutions proposed in the background art are currently not available on the market for the storage of important documents and files and valuables, the important documents and files and valuables are stored in storage boxes that do not have a fireproof function, but fire accidents occur frequently, and once a fire source is in contact with a storage box that does not have the fireproof function, the documents, files, and valuables are all destroyed.

To achieve the above objective, the present disclosure provides the following technical solution: A storage box having fireproof and heat-insulating functions, including a folding storage box body provided with a code lock, where the folding storage box body is provided with a box cover, the box cover matches the folding storage box body, a top cover is arranged above the folding storage box body, a same zipper is sewn on the folding storage box body and the top cover, two zipper heads are movably installed on the zipper, the code lock is clamped on the two zipper heads, and the folding storage box body, the box cover and the top cover are each composed of an outer fireproof cloth, heat-insulating cotton, an auxiliary forming plate, and an inner fireproof cloth.

Preferably, a bottom plate is arranged below the folding storage box body, a plurality of buffer springs are fixedly installed on a top side of the bottom plate, a same connecting plate is fixedly installed at top ends of the buffer springs, pressing rods are arranged at four corners of the connecting plate, and an abutting plate is fixedly installed on the pressing rods and is in close contact with the folding storage box body.

Preferably, supporting seats are fixedly installed at four corners of the connecting plate, the supporting seats are each provided with a rotating hole, and a rotating shaft is rotatably installed in the rotating hole and fixedly installed on the pressing rod.

Preferably, rubber backing plates are fixedly installed at four corners of a bottom side of the bottom plate, and bottom sides of the rubber backing plates are provided with anti-slip lines.

Preferably, a fixing plate is fixedly installed on the supporting seat, and a spring is fixedly installed on the fixing plate and the pressing rod.

Preferably, the outer fireproof cloth, heat-insulating cotton, the auxiliary forming plate and the inner fireproof cloth are sewn by using high-temperature lines, and a surface of the outer fireproof cloth is coated with a waterproof coating.

Preferably, two carrying straps are sewn on the folding storage box body, and a supporting plate is placed in the folding storage box body.

The present disclosure has the following beneficial effects:

In the present disclosure, fireproof and heat-insulating cotton, an auxiliary forming material and an internal fireproof material are made into a double-layer fireproof composite by using a laminating or sewing process, the material has high plasticity and can be made into boxes of different specifications by using various folding accommodating methods, and the product is hardware and has fireproof and heat-insulating functions; it is ensured that important items in the product are not damaged when the product is on the fire source for a certain period of time, and thus effective fire prevention and heat insulation are implemented. The fireproof material is resistant to high temperature of 500° C. to over 1000° C., and open flames generally cannot cause damage to the product, which can reduce fires and protect lives and property.

In the present disclosure, a folding storage box body can be in direct contact with open flames, and the product is resistant to high temperature, does not spontaneously ignite and has certain moisture-proof and heat-insulating functions. In the event of a fire, because the material is resistant to high temperature and does not spontaneously ignite, stored items cannot be in contact with open flames, so that they are protected, and the spread of the fire source can be controlled. When a plurality of fireproof boxes are stored together, a firewall is formed outside, which better protects important items and property and gives more time to firefighters to rescue important items. The material is not only fireproof, but also waterproof, has a certain moisture-proof function, better protects important documents, and prevents items from molding. In a large fire, if the temperature is too high, this product can protect items stored in the product from damage caused by high temperature and burning within a certain period of time. Generally, in case of contact with small fires, the safety of items can be ensured. When flammable and explosive items such as a battery are stored, if there is a fire inside, the extension of the fire source can be controlled. Therefore, fire accidents are reduced.

In the present disclosure, a plurality of buffer springs can effectively offset the vibration of the folding storage box body in use, so that the safety of valuables stored in the folding storage box body can be ensured. In addition, the storage box can be waterproof and prevent items in the folding storage box body from being damped, thereby ensuring the storage environment in the folding storage box body and meeting people's needs.

### BRIEF DESCRIPTION OF THE DRAWINGS

FIG. 1 is a perspective schematic structural diagram of a storage box having fireproof and heat-insulating functions according to the present disclosure;

FIG. 2 is a schematic diagram of a separated structure of a storage box having fireproof and heat-insulating functions according to the present disclosure;

FIG. 3 is a schematic structural diagram of a part A in FIG. 2 of a storage box having fireproof and heat-insulating functions according to the present disclosure;

FIG. 4 is a schematic structural diagram of a cross section of a storage box having fireproof and heat-insulating functions according to the present disclosure;

FIG. 5 is a schematic top view of the structure of a storage box having fireproof and heat-insulating functions according to the present disclosure;

FIG. 6 is a schematic side view of the structure of a storage box having fireproof and heat-insulating functions according to the present disclosure;

FIG. 7 is a schematic structural diagram of a part B in FIG. 6 of a storage box having fireproof and heat-insulating functions according to the present disclosure; and

FIG. 8 is a schematic bottom view of the structure of a storage box having fireproof and heat-insulating functions according to the present disclosure.

In the figures: 1. folding storage box body; 101. outer fireproof cloth; 102. heat-insulating cotton; 103. auxiliary forming plate; 104. inner fireproof cloth; 2. box cover, 3. top cover; 4. zipper, 5. carrying strap; 6. supporting plate; 7. zipper head; 8. code lock; 9. bottom plate; 10. connecting plate; 11. buffer spring; 12. supporting seat; 13. rotating hole; 14. rotating shaft; 15. pressing rod; 16. abutting plate; 17. fixing plate; 18. spring; 19. rubber backing plate.

### DESCRIPTION OF THE EMBODIMENTS

The following clearly and completely describes the technical solutions in the embodiments of the present disclosure with reference to accompanying drawings in the embodiments of the present disclosure. Apparently, the described embodiments are merely some rather than all of the embodiments of the present disclosure.

### Embodiment 1

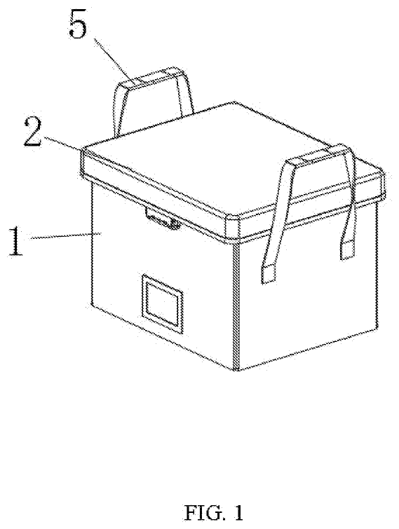

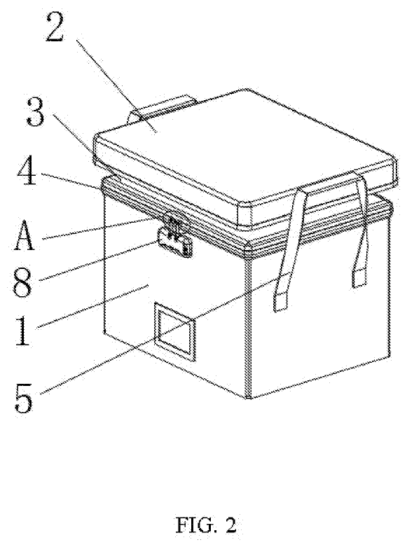

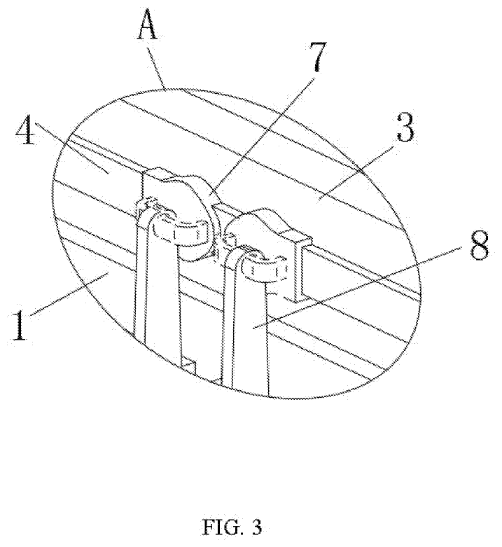

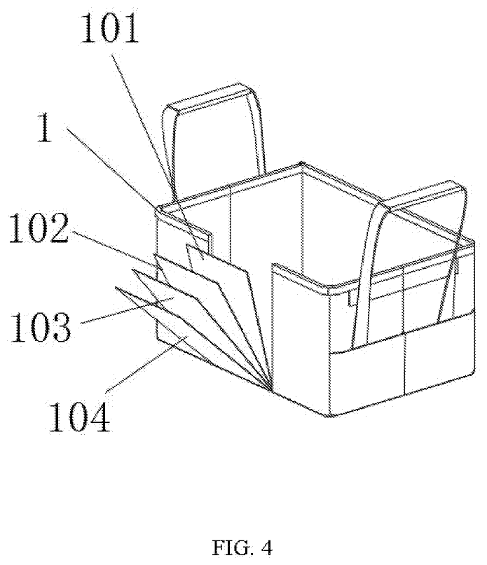

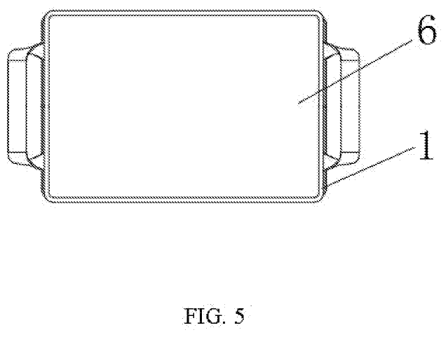

Referring to FIGS. 1-5, a storage box having fireproof and heat-insulating functions includes a folding storage box body 1, where the folding storage box body 1 includes an outer fireproof cloth 101, heat-insulating cotton 102, an auxiliary forming plate 103 and other laminating materials or an inner fireproof cloth 104 which are integrated through laminating and sewing with a fireproof thread to become a multilayer fireproof and heat-insulating composite, and then the finished product is sewn via a high-temperature-resistant fireproof thread, or the product is seamlessly combined via mold assembly via high-temperature-resistant components.

The sealing method may be one of upper and lower cover sealing, hanging buckle sealing, zipper 4 sealing, magnet attraction sealing, and fireproof zipper sealing. After sealing, items stored in the product cannot be in contact with open flames.

The folding storage box body 1, a box cover 2 and a top cover 3 are made by compositing the outer fireproof cloth 101, the heat-insulating cotton 102, the auxiliary forming plate 103 and the inner fireproof cloth 104. The composite includes a first layer which is the outer fireproof cloth 101, a second layer which is the heat-insulating cotton 102, a third layer which is the auxiliary forming plate 103 and a fourth layer which is other laminating materials or the inner fireproof cloth 104. Adjustments can be made based on actual usage scenarios. If only external fire protection is required, the first fireproof layer is reserved; if internal and external multilayer fire protection is required, the fourth layer is made of a fireproof cloth. The second and third layer of materials can also be replaced. The fireproof cloth has a certain heat-insulating function. If strong heat insulation is needed, a heat insulation layer is added, and if strong heat insulation is not required, the heat insulation layer can be omitted.

After the multiple layers of materials are combined into a finished product through a high temperature wire or a high-temperature-resistant mold part, the outer layer is fully fireproof, and the inner layer is made of a fireproof material to achieve fire protection inside and outside, so as to achieve better protection effects. If flammable items such as a battery need to be stored, the inner layer is a fireproof layer.

The surface layer material of the product is waterproof: The surface layer of the finished product is waterproof. The external fireproof material coating is a waterproof coating. Rainwater cannot penetrate the coating, but the entire box cannot be immersed in water.

The setting of the code lock 8 better protects important items and privacy in the folding storage box body.

### Embodiment 2

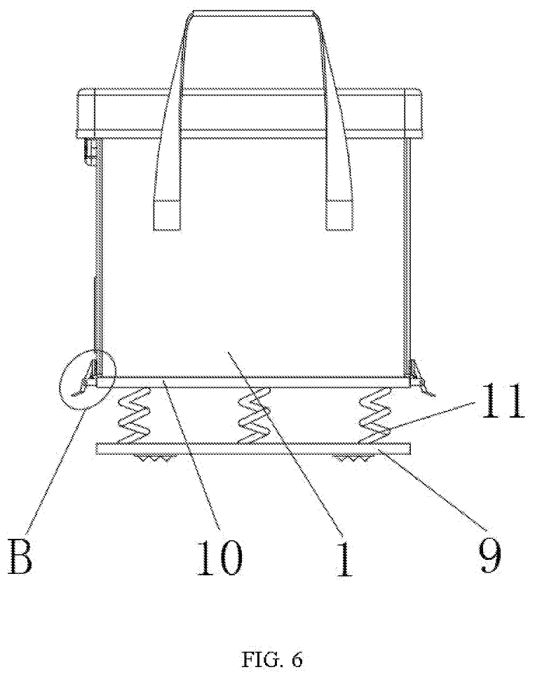

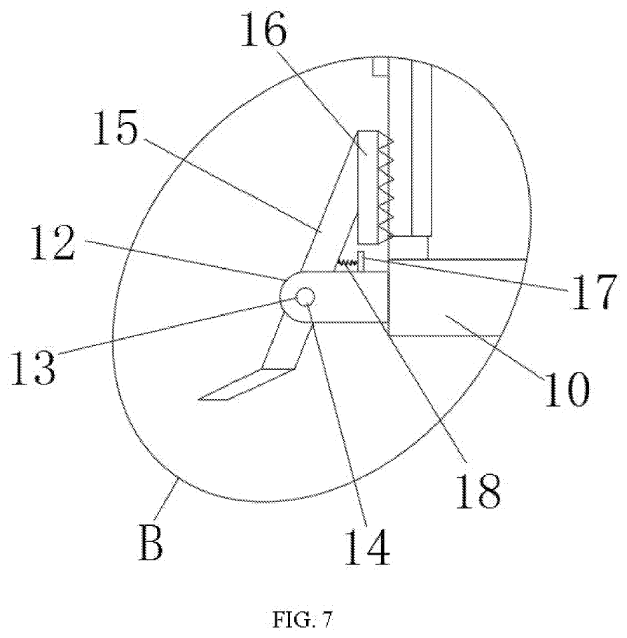

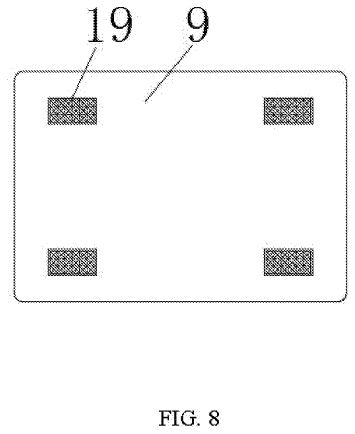

Referring to FIGS. 6-8, a storage box having fireproof and heat-insulating functions includes a folding storage box body 1. When the folding storage box body 1 is subjected to vibration, the vibration can be offset through the setting of a plurality of buffer springs 11. When valuables are stored in the folding storage box body 1, the shattering of items can be avoided through cushioning, thereby ensuring the safety of the items in the folding storage box body 1.

In addition, when a connecting plate 10 is installed, four abutting plates 16 can clamp the folding storage box body 1 by pressing a plurality of pressing rods 15, making the installation convenient. Similarly, the connecting plate 10 can be easily disassembled and reused, thereby saving social resources.

The working principle of the present disclosure is as follows.

In the present disclosure, a folding storage box body 1 can be in direct contact with open flames, and the product is resistant to high temperature, does not spontaneously ignite and has certain moisture-proof and heat-insulating functions. In the event of a fire, because the material is resistant to high temperature and does not spontaneously ignite, stored items cannot be in contact with open flames, so that they are protected, and the spread of the fire source can be controlled. When a plurality of fireproof boxes are stored together, a firewall is formed outside, which better protects important items and property and gives more time to firefighters to rescue important items. The material is not only fireproof, but also waterproof, has a certain moisture-proof function, better protects important documents, and prevents items from molding. In a large fire, if the temperature is too high, items stored in the product can be protected from damage caused by high temperature and burning within a certain period of time. Generally, in case of contact with small fires, the safety of items can be ensured. When flammable and explosive items such as a battery are stored, if there is a fire inside, the extension of the fire source can be controlled. Therefore, fire accidents are reduced. In addition, When the folding storage box body 1 is subjected to vibration, the vibration can be offset through the setting of a plurality of buffer springs 11, thereby ensuring the safety of the items in the folding storage box body 1. In addition, when a connecting plate 10 is installed, two pressing rods 15 on the same side can be first pressed, so that the pressing rods 15 rotate in a rotating hole 13 through a rotating shaft 14, the pressing rods 15 rotate and pull springs 18 for stretching, then one side of the folding storage box body 1 is placed on the connecting plate 10, two pressing rods 15 are loosened, so that the two pressing rods 15 return under the drawing force of two springs 18, to drive two abutting plates 16 to abut against the folding storage box body 1 and then press the folding storage box body 1, and two other pressing rods 15 are sequentially pressed. Therefore, the folding storage box body 1 can be completely placed on the connecting plate 10, and two other pressing rods 15 are loosened, so that four abutting plates 16 can clamp the folding storage box body 1, making the installation convenient.

The above descriptions are merely preferred specific implementations of the present disclosure, but the protection scope of the present disclosure is not limited thereto. Equivalent replacements or changes made by any person skilled in art according to the technical solutions and conception of the present disclosure within the technical scope disclosed in the present disclosure should fall within the protection scope of the present disclosure.

1. A storage box having fireproof and heat-insulating functions, comprising a folding storage box body (1) provided with a code lock (8), wherein the folding storage box body (1) is provided with a box cover (2), the box cover (2) matches the folding storage box body (1), a top cover (3) is arranged above the folding storage box body (1), a same zipper (4) is sewn on the folding storage box body (1) and the top cover (3), two zipper heads (7) are movably installed on the zipper (4), the code lock (8) is clamped on the two zipper heads (7), and the folding storage box body (1), the box cover (2) and the top cover (3) are each composed of an outer fireproof cloth (101), heat-insulating cotton (102), an auxiliary forming plate (103), and an inner fireproof cloth (104).

2. The storage box having fireproof and heat-insulating functions according to claim 1, wherein a bottom plate (9) is arranged below the folding storage box body (1), a plurality of buffer springs (11) are fixedly installed on a top side of the bottom plate (9), a same connecting plate (10) is fixedly installed at top ends of the buffer springs (11), pressing rods (15) are arranged at four corners of the connecting plate (10), and an abutting plate (16) is fixedly installed on the pressing rods (15) and is in close contact with the folding storage box body (1).

3. The storage box having fireproof and heat-insulating functions according to claim 2, wherein supporting seats (12) are fixedly installed at four corners of the connecting plate (10), the supporting seats (12) are each provided with a rotating hole (13), and a rotating shaft (14) is rotatably installed in the rotating hole (13) and fixedly installed on the pressing rod (15).

4. The storage box having fireproof and heat-insulating functions according to claim 2, wherein rubber backing plates (19) are fixedly installed at four corners of a bottom side of the bottom plate (9), and bottom sides of the rubber backing plates (19) are provided with anti-slip lines.

5. The storage box having fireproof and heat-insulating functions according to claim 3, wherein a fixing plate (17) is fixedly installed on the supporting seat (12), and a spring (18) is fixedly installed on the fixing plate (17) and the pressing rod (15).

6. The storage box having fireproof and heat-insulating functions according to claim 1, wherein the outer fireproof cloth (101), heat-insulating cotton (102), the auxiliary forming plate (103) and the inner fireproof cloth (104) are sewn by using high-temperature lines, and a surface of the outer fireproof cloth (101) is coated with a waterproof coating.

7. The storage box having fireproof and heat-insulating functions according to claim 1, wherein two carrying straps (5) are sewn on the folding storage box body (1), and a supporting plate (6) is placed in the folding storage box body (1).
